(19) United States
(12) Patent Application Publication
(10) Pub. No.: US 2007/0209342 A1
(43) Pub. Date: Sep. 13, 2007

(54) Convenient vacuum cleaner for collecting dust or liquid

(76) Inventor: Kuo-Chin Cho, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/372,013

(22) Filed: Mar. 10, 2006

(51) Int. Cl. B01D 46/00

(52) U.S. Cl. 55/461

(57) ABSTRACT

A convenient vacuum cleaner for collecting dust or liquid is provided with a filter in the collecting tank, and a porous bag is provided to cover the filter. The filter is provided with a base seat at the bottom, the base seat is provided with a stopping portion thereon, and a receiving room formed in the stopping portion for a floating ball to be placed therein, and spaced through holes are disposed in the lower circumference of the stopping portion. The porous bag is made of non-woven cloth or other material capable of filtering and provided to cover the filter, so as to prevent dust or solid impurities from entering the filter.

### BACKGROUND OF THE INVENTION

1. Field of the Invention

The present invention relates to a convenient vacuum cleaner for collecting dust or liquid with innovatory features, and more particularly to a convenient vacuum cleaner which is provided with a base seat in the filter in the collecting tank and a porous bag covering the filter, so as to conveniently and efficiently achieve the function of collecting dust or liquid.

2. Brief Description of the Prior Art

The inventor of the present invention had filed applications Ser. Nos. 10/420,793, 10/651,958, 10/683,402, 11/047,648, 11/230,663 to improve the dust-collecting or filtering functions of an industrial vacuum cleaner.

However, the huge main body of a prior industrial vacuum cleaner is necessary for a wide working place, and it is not convenient for a small or narrow place to use a big industrial vacuum cleaner. Moreover, a prior filter is applied to filter liquid and is not capable of filtering and collecting solid impurities.

### SUMMARY OF THE INVENTION

Therefore, the objective of the present invention is to provide a vacuum cleaner for collecting dust or liquid that can substantially obviate the drawbacks of the related prior vacuum cleaners.

An objective of the present invention is to provide a vacuum cleaner which is handy and convenient to be applied in a small place for collecting dust or liquid.

Another objective of the present invention is to provide a vacuum cleaner which is provided with a base seat at the bottom of a filter, so as to receive a floating ball therein.

Yet another objective of the present invention is to provide a vacuum cleaner which is provided with a porous bag to cover the filter, so as to prevent dust or solid impurities from entering the filter.

Accordingly, a convenient vacuum cleaner for collecting dust or liquid in the present invention is provided with a filter in the collecting tank, and a porous bag is provided to cover the filter. The filter is provided with a base seat at the bottom, the base seat is provided with a stopping portion thereon, and a receiving room formed in the stopping portion for a floating ball to be placed therein, and spaced through holes are disposed in the lower circumference of the stopping portion. The porous bag is made of non-woven cloth at the best or other material capable of filtering and provided to cover the filter, so as to prevent dust or solid impurities from entering the filter.

### BRIEF DESCRIPTION OF THE DRAWINGS

Other features and advantages of the present invention will become apparent in the following detailed description of the preferred embodiment with reference to the accompanying drawings, in which:

FIG. 1 is a perspective exploded view of the filter and the porous bag in accordance with the present invention;

FIG. 2 is a side sectional view of the filter and the porous bag in assembled configuration in accordance with the present invention;

FIG. 3 is schematic sectional view showing the convenient vacuum cleaner in accordance with the present invention being applied to collect liquid and solid impurities as well as an enlarged view of the filter;

FIG. 4 is a schematic sectional view showing the convenient vacuum cleaner in accordance with the present invention being applied to collect liquid as well as an enlarged view of the filter; and,

FIG. 5 is a perspective view of the convenient vacuum cleaner in accordance with the present invention.

### DETAILED DESCRIPTION OF THE PREFERRED EMBODIMENT

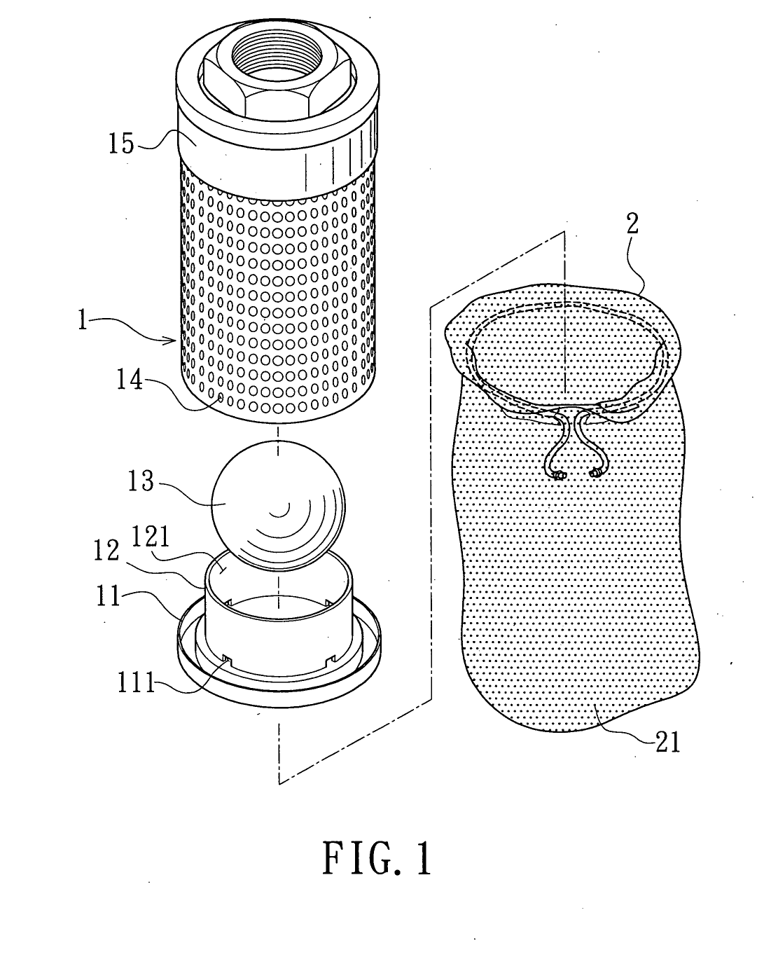

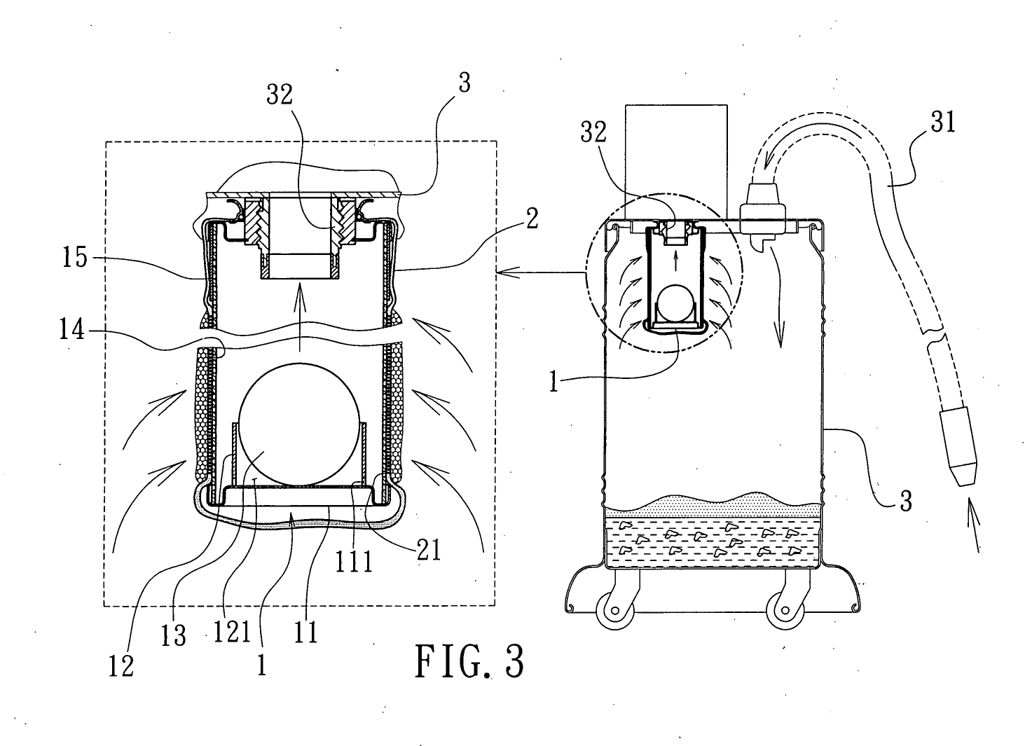

Referring to FIG. 1, an embodiment of the convenient vacuum cleaner 3 for collecting dust or liquid in the present invention is provided with a filter 1 in the collecting tank, as shown in FIG. 3, and a porous bag 2 is provided to cover the filter 1. The filter 1 is provided with a base seat 11 at the bottom, the base seat 11 is provided with a stopping portion 12 thereon, and a receiving room 121 formed in the stopping portion 12 for a floating ball 13 to be placed therein, and spaced through holes 111 are disposed in the lower circumference of the stopping portion 12. The porous bag 2 is made of non-woven cloth at the best or other material capable of filtering and provided to cover the filter 1, so as to prevent dust or solid impurities from entering the filter 1.

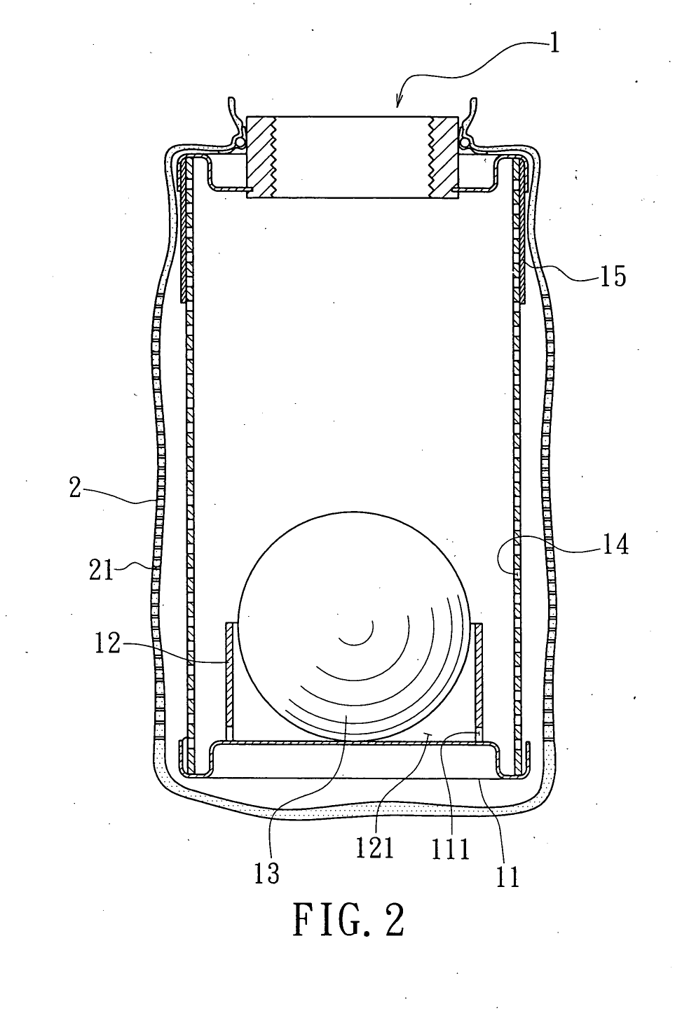

While being assembled, referring to FIG. 2, a floating ball 13 is placed in the receiving room 121 of the stopping portion 12, the base seat 11 is inlaid in the bottom of the filter 1, and then the porous bag 2 is sleeved on the filter 1.

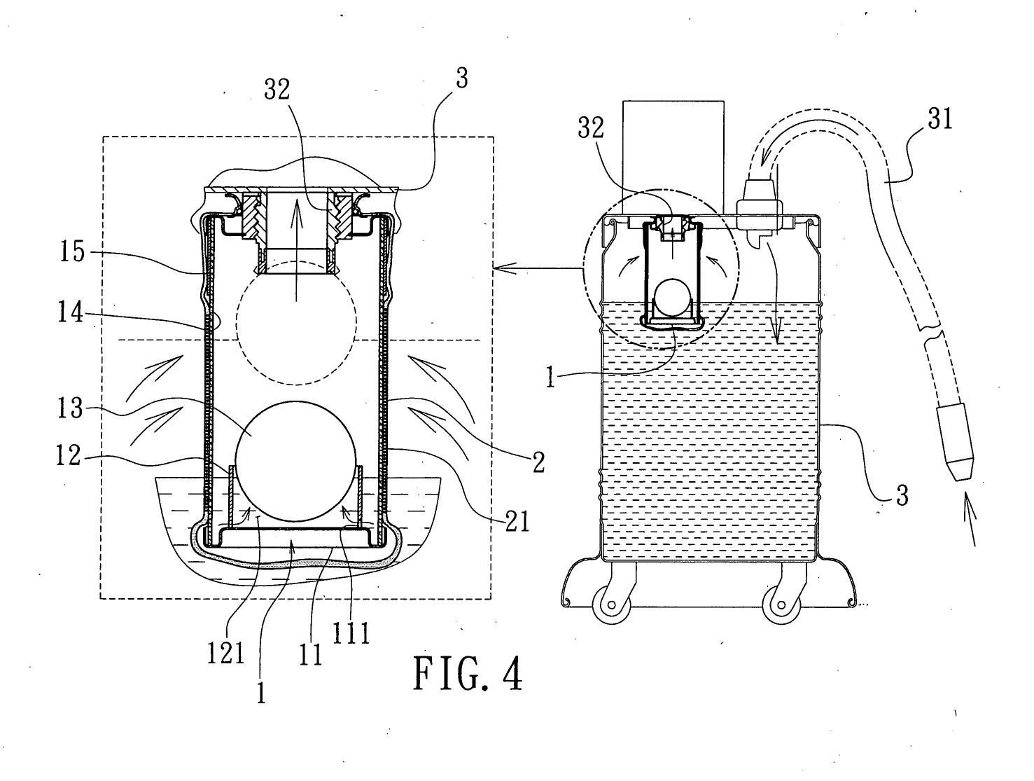

While being applied, referring to FIGS. 3 and 4, when the vacuum cleaner 3 being started, the sucking pipe 31 is used to suck up solid articles, such as metal scraps, plastic grains, soy beans, dust, or liquid, such as waste water, chemical solution, into the collecting tank of the vacuum cleaner 3. If the height of the liquid (or solid articles) in the collecting tank is lower than that of the floating ball 13, when the air in the collecting tank touches the stopping portion 12, the air will be stopped by the stopping portion 12, so as to prevent from producing airflow, and the floating ball 13 can be fixed in the receiving room 121. When the liquid (or solid articles) in the collecting tank ascend to touch the floating ball 13, if there are solid impurities in the liquid, the solid impurities will be filtered by the porous bag 2 covering the filter 1, and then the liquid flows through the pores 21 of the porous bag 2 and the meshed holes 14 of the filter 1 into the filter 1 to make the floating ball 13 slowly ascend accordingly. When the floating ball 13 is close to the airtight non-hole section 15 of the filter 1, the air is stopped by the surface of the airtight non-hole section. 15 and can not enter, and the floating ball 13 will be sucked by the strong suction of the air-exhausting exit 32 to separate from the liquid and fully seal up the air-exhausting exit 32. On the contrary, if there is no solid impurity, the porous bag 2 may be taken off the filter 1 to let the liquid flow through the meshed holes 14 of the filter 1 and enter the through holes 111 of the stopping portion 12, so as to force the floating ball 13 ascend to separate from the liquid and fully seal up the air-exhausting exit 32. Besides, when the liquid in the collecting tank of the vacuum cleaner 3 is full, the cover 33 is lifted, and the filter 1 is separated from the collecting tank of the vacuum cleaner 3 to let the remaining liquid in the receiving room 121 of the base seat 11 flow through the through holes 111 accordingly.

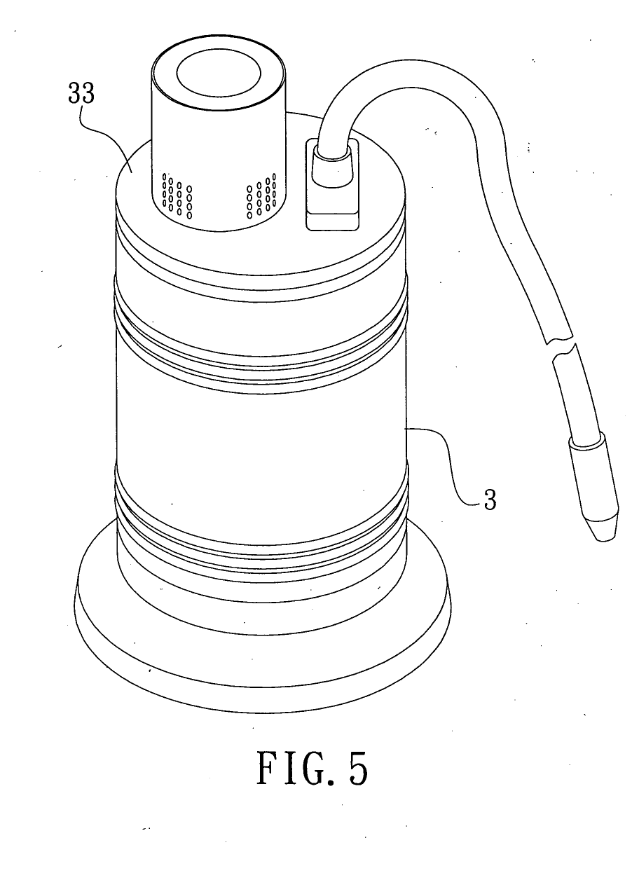

The convenient vacuum cleaner for collecting dust or liquid in the present invention can achieve the effect and purpose of collecting liquid or solid impurities, it is handy and has a cute appearance of cylinder-shaped design, as shown in FIG. 5, and it is not only suitable for industrial use but also suitable to be used in a community, a hospital, a house or a certain place.

While the preferred embodiment of the invention have been described above, it will be recognized and understood that various modifications may be made therein, and the appended claims are intended to cover all such modifications which may fall within the spirit and scope of the invention.

What is claimed is:

1. A filter being provided in the collecting tank of a convenient vacuum cleaner comprising:
a base seat being provided at the bottom of said filter; and,
a porous bag being provided to cover said filter.

2. The filter of a convenient vacuum cleaner as recited in claim 1, wherein said base seat is provided with a stopping portion thereon, and a receiving room is formed in said stopping portion for a floating ball to be placed therein.

3. The filter of a convenient vacuum cleaner as recited in claim 1, wherein through holes are disposed in the lower circumference of said stopping portion.

4. The filter of a convenient vacuum cleaner as recited in claim 1, wherein said porous bag is made of non-woven cloth or material capable of filtering.
